(19) United States
(12) Patent Application Publication
(10) Pub. No.: US 2005/0282061 A1
(43) Pub. Date: Dec. 22, 2005

(54) Catalyst support for an electrochemical fuel cell

(76) Inventor: Stephen A. Campbell, Maple Ridge (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/873,760

(22) Filed: Jun. 22, 2004

(51) Int. Cl. H01M 4/96; H01M 8/10

(52) U.S. Cl. 429/44; 429/30

(57) ABSTRACT

Corrosion of the carbon catalyst support may occur at both the anode and cathode catalyst layers within an electrochemical fuel cell. Such corrosion may lead to reduced performance and/or decreased lifetimes of the fuel cell. Nevertheless, carbon supports have many desirable properties as catalyst supports including high surface area, high electrical conductivity, good porosity and density. To reduce or eliminate corrosion of the carbon catalyst support, the carbon support may have a metal surface treatment and, in particular, a metal carbide surface treatment. Suitable metal carbides include titanium, tungsten and molybdenum. In this manner, the metal carbide surface treatment protects the underlying carbon support from corrosion while maintaining the desirable characteristics of the carbon support.

### BACKGROUND OF THE INVENTION

1. Field of the Invention

The present invention relates to catalysts for electrochemical fuel cells and more particularly to a support material for the catalyst.

2. Description of the Related Art

Fuel cell systems are currently being developed for use as power supplies in numerous applications, such as automobiles and stationary power plants. Such systems offer the promise of economically delivering power with environmental and other benefits. To be commercially viable, however, fuel cell systems need to exhibit adequate reliability in operation, even when the fuel cells are subjected to conditions outside the preferred operating range.

Fuel cells convert reactants, namely fuel and oxidant, to generate electric power and reaction products. Fuel cells generally employ an electrolyte disposed between two electrodes, namely a cathode and an anode. A catalyst typically induces the desired electrochemical reactions at the electrodes. Preferred fuel cell types include polymer electrolyte membrane (PEM) fuel cells that comprise an ion-exchange membrane as electrolyte and operate at relatively low temperatures.

A broad range of reactants can be used in PEM fuel cells. For example, the fuel stream may be substantially pure hydrogen gas, a gaseous hydrogen-containing reformate stream, or methanol. The oxidant may be, for example, substantially pure oxygen or a dilute oxygen stream such as air.

During normal operation of a PEM fuel cell, fuel is electrochemically oxidized at the anode catalyst, typically resulting in the generation of protons, electrons, and possibly other species depending on the fuel employed. The protons are conducted from the reaction sites at which they are generated, through the ion-exchange membrane, to electrochemically react with the oxidant at the cathode catalyst. The catalysts are preferably located at the interfaces between each electrode and the adjacent membrane.

PEM fuel cells employ a membrane electrode assembly (MEA), which comprises an ion-exchange membrane disposed between two fluid diffusion layers. Separator plates, or flow field plates for directing the reactants across one surface of each fluid diffusion layer, are disposed on each side of the MEA.

Each electrode contains a catalyst layer between the respective fluid diffusion layer and the ion-exchange membrane, comprising an appropriate catalyst, which is located next to the ion-exchange membrane. The catalyst may be a metal black, an alloy or a supported metal catalyst, for example, platinum on carbon. The catalyst layer typically contains an ionomer, which may be similar to that used for the ion-exchange membrane (for example, up to 30% by weight Nafion® brand perfluorosulfonic-based ionomer). The catalyst layer may also contain a binder, such as polytetrafluoroethylene (PTFE).

The electrodes may also contain a substrate (typically a porous electrically conductive sheet material) that may be employed for purposes of reactant distribution and/or mechanical support. This support may be referred to as the fluid diffusion layers. Optionally, the electrodes may also contain a sublayer (typically containing an electrically conductive particulate material, for example, finely comminuted carbon particles, also known as carbon black) between the catalyst layer and the substrate. A sublayer may be used to modify certain properties of the electrode (for example, interface resistance between the catalyst layer and the substrate).

For a PEM fuel cell to be used commercially in either stationary or transportation applications, a sufficient lifetime is necessary. For example, 5,000 hour operations may be routinely required. In practice, there are significant difficulties in consistently obtaining sufficient lifetimes as many of the degradation mechanisms and effects remains unknown. Accordingly, there remains a need in the art to understand degradation of fuel cell components and to develop design improvements to mitigate or eliminate such degradation. The present invention fulfills this need and provides further related advantages.

### BRIEF SUMMARY OF THE INVENTION

Corrosion of the carbon catalyst support may occur at both the anode and cathode catalyst layers within an electrochemical fuel cell. Such corrosion may lead to reduced performance and/or decreased lifetime of the fuel cell. Nevertheless, carbon supports have many desirable properties as catalyst supports including high surface area, high electrical conductivity, good porosity and density. To reduce or eliminate corrosion of the carbon catalyst support, the carbon support may have a metal surface treatment and in particular, a catalyst for an electrochemical fuel cell may comprise a catalyst support comprising carbon and a metal surface treatment on the carbon; and a metal catalyst deposited on the catalyst support. The metal treatment may be a metal carbide surface treatment. Suitable metal carbides include titanium, tungsten and molybdenum.

In this manner, the metal carbide surface treatment may protect the underlying carbon support from corrosion while maintaining desirable characteristics of the carbon support. The metal surface treatment may only cover a portion of the surface area of the carbon support or substantially the entire surface of the carbon. The carbon may be, for example, a carbon black or a graphitized carbon. In addition or alternatively, the carbon may be doped with boron, nitrogen or phosphorus.

The catalyst may also be in a catalyst ink. A membrane electrode assembly for an electrochemical fuel cell comprises:
an anode and a cathode fluid diffusion layer;
an ion-exchange membrane interposed between the fluid diffusion layers;
an anode catalyst layer comprising an anode catalyst interposed between the anode fluid diffusion layer and the ion-exchange membrane; and
a cathode catalyst layer comprising a cathode catalyst interposed between the cathode fluid diffusion layer and the ion-exchange membrane.

In such a membrane electrode assembly, at least one of the anode and cathode catalysts comprises a catalyst support comprising carbon and a metal surface treatment on the carbon and a metal catalyst deposited on the catalyst support. Further, the membrane electrode assembly may be in an electrochemical fuel cell. Similarly, an electrochemical fuel cell stack may comprise at least one such electrochemical fuel cell.

Similarly, a fuel cell electrode structure may comprise a substrate and a catalyst disposed on a surface of the substrate. The catalyst comprises a catalyst support comprising carbon and a metal surface treatment on the carbon; and a metal catalyst deposited on the catalyst support. Typical substrates for electrochemical fuel cells are fluid diffusion layers and ion-exchange membranes.

In another aspect, a method of making a catalyst for an electrochemical fuel cell comprises depositing a metal on a surface of a catalyst support comprising carbon; heating the catalyst support to form a metal carbide surface treatment on the catalyst support; and depositing a metal catalyst on the catalyst support. Suitable metals include tungsten, titanium and molybdenum and suitable temperatures for the heating step include heating the catalyst support at 850-1000° C., more particularly at 900-1000° C.

The depositing and heating steps may be performed sequentially. For example, a metal precursor, such as a metal carbonate or ammonium tungstate, may be reduced in an aqueous solution. The metal carbide is then formed as a result of reaction between the reduced metal and the carbon support during the heating step. Alternatively, the depositing and heating steps may be performed simultaneously. In such an embodiment a metal precursor, for example, an organometallic such as TYZOR organic titanate, decomposes under the heat treatment step to directly form the metal carbide on the surface of the carbon catalyst support.

These and other aspects of the invention will be evident upon reference to the attached figures and following detailed description.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

### BRIEF DESCRIPTION OF THE DRAWINGS

FIG. 1 is a graph illustrating the thermal gravimetric analysis results for two platinum supported catalysts.

FIG. 2 is a graph illustrating the ex-situ electrochemical oxidation of two platinum supported catalyst.

FIG. 3 is a cyclic voltammogram of 40% platinum catalyst on an untreated XC72R carbon support before and after the oxidation shown in FIG. 2.

FIG. 4 is a cyclic voltammogram of 40% platinum catalyst on a tungsten treated XC72R carbon support before and after the oxidation shown in FIG. 2.

### DETAILED DESCRIPTION OF THE INVENTION

In operation, the output voltage of an individual fuel cell under load is generally below one volt. Therefore, in order to provide greater output voltage, numerous cells are usually stacked together and are connected in series to create a higher voltage fuel cell stack. Fuel cell stacks can then be further connected in series and/or parallel combinations to form larger arrays for delivering higher voltages and/or currents.

However, fuel cells in series are potentially subject to voltage reversal, a situation in which a cell is forced to the opposite polarity by the other cells in the series. This can occur when a cell is unable to produce the current forced through it by the rest of the cells. Groups of cells within a stack can be driven into voltage reversal by other stacks in an array. Aside from the loss of power associated with one or more cells going into voltage reversal, this situation poses reliability concerns. Undesirable electrochemical reactions may occur, which may detrimentally affect fuel cell components. For example, carbon corrosion can occur as follows:
C+2H₂O→CO₂+4H⁺+4e (1)
The catalyst carbon support in the anode structure corrodes, with eventual dissolution of the platinum-based catalyst from the support, and the anode fluid diffusion layer may become degraded due to corrosion of the carbon present in the fluid diffusion layer structure. In cases where the bipolar flow field plates are based upon carbon, the anode flow field may also be subjected to significant carbon corrosion, thereby resulting in surface pitting and damage to the flow field pattern.

However, corrosion is not limited to the anode and may also occur at the cathode. The standard electrode potential for reaction (1) at 25° C. is 0.207 V vs SHE. Thus at all potentials above 0.207 V, the carbon is thermodynamically unstable. As PEM fuel cells typically operate at potentials in excess of 0.2 V, carbon would be expected to corrode from the cathode where it is in contact with the electrolyte. Ex situ results on a fluid diffusion electrode having a cathode catalyst comprising 40% Pt on a Vulcan XC72R carbon support confirmed this and showed a rate of carbon loss at 1.42 V of 1650 mg/day. Another similar trial using a cathode catalyst comprising 40% Pt on a Shawinigan carbon support, showed a rate of carbon loss at 1.42 V of 1260 mg/day.

To increase oxidative stability, the carbon catalyst support may have a metal surface treatment. In particular, the surface may be treated to form a metal carbide coating. Suitable metal carbides include: titanium carbide, tungsten carbide and molybdenum carbide. The metal carbide surface treatment may be formed in a number of ways. For example, the metal carbide may be formed from an aqueous solution using NaBH₄ to reduce the metal onto the surface of a carbon support. For example, ammonium tungstate may be reduced with NaBH₄ to form a tungsten carbide on the surface of the carbon support. Metal carbonates may also be suitable as metal precursors instead of ammonium tungstate. Alternatively, thermal decomposition at, for example 1000° C., of an organometallic may be used in the presence of the carbon support. A suitable organometallic may include TYZOR organic titanates available from Dupont.

After the metal is reduced on the carbon support, a heat treatment step under an inert atmosphere may be used to form the metal carbide. Suitable temperatures for the heat treatment step includes, for example 850-1100° C., more particularly 900-1000° C. An appropriate inert atmosphere would be, for example, under nitrogen.

Alternatively, thermal decomposition in an inert atmosphere of a metal precursor, such as an organometallic, may form the metal carbide directly on the carbon support. A suitable organometallic includes, for example, TYZOR organic titanates available from Dupont. Suitable temperatures for the heat treatment step includes, for example 850-1100° C., more particularly 900-1000° C. An appropriate inert atmosphere would be, for example, under nitrogen.

To be useful as a catalyst support, a material preferably has two main properties: a high surface area and high electrical conductivity. Traditionally, high surface area carbon blacks, such as Vulcan XC72R or Shawinigan, have been used as catalyst supports to obtain a high surface area catalyst powder. In order for the conductive carbon to carry the catalyst, the BET specific surface area of the conductive carbon may be between 50 m²/g and 3000 m²/g, such as between 100 m²/g and 2000 m²/g. A surface treatment with metal carbide maintains a relatively high surface area while increasing oxidative stability.

Carbon is electrically conductive and different metal carbides have different electrical conductivities. Tungsten carbide (WC) is more conductive than titanium carbide (TiC) which is more conductive than molybdenum carbide (MO₂C) (see, for example, Pierson, Hugh O., Handbook of refractory carbides and nitrides: properties, characteristics, processing and applications, Noyes Publications, 1996).

The carbon support may be a carbon black such as Vulcan XC72R or Shawinigan. Alternatively, the carbon support may be a graphitized carbon. Graphitized carbon also shows increased oxidative stability relative to non-graphitized carbon black and the combination of a graphitized carbon surface treated with a metal carbide may demonstrate even greater oxidative stability. However, in addition to a high surface area and high electric conductivity as mentioned above, carbon blacks have other structural properties conducive to use as a catalyst support including porosity and density. Some or all of these structural properties may be diminished by using a graphitized carbon instead. In particular, the graphitization process may cause a reduction in surface area which may render it difficult to obtain the desired dispersion of the platinum on the surface for use in fuel cell applications.

In addition or alternatively, the carbon may be doped with, for example, boron, nitrogen or phosphorus as disclosed in U.S. Patent Application No. 2004/0072061.

Instead of using a surface coating of metal carbide on a carbon support, the support may comprise only the metal carbide. While such a support may show increased oxidative stability, metal carbides tend to exist as small, hard, dense spheres such that their use may not be preferred in a fuel cell. Further, the high density of these materials makes it difficult to manufacture stable inks for screen printing catalyst layers. However, by treating the surface of carbon with these metal carbides as discussed above, a carbon support may be obtained which demonstrates the benefits of the carbon support, namely high surface area, good porosity and density as well as the benefits of the metal carbide, namely increased oxidative stability.

The platinum catalyst may then be deposited on the surface of the catalyst support using traditional methods. Instead of platinum, other noble metals such as rhodium, ruthenium, iridium, palladium, osmium and platinum alloys thereof may be used. In addition, there is also an effort to find less expensive non-noble metal catalysts for fuel cell applications. Nevertheless, the type of catalyst used in the fuel cell is not important to the scope of the present invention.

The platinum catalyst is supported on the surface of the catalyst support. Accordingly, the catalyst particles are typically smaller than the support. For example the catalyst particle diameter may be in the range of 0.5 nm to 20 nm, for example between 1 nm and 10 nm. Smaller diameters of the catalyst particles results in an increased surface area of the catalyst for the same total loading and hence may be desired. In comparison, the average particle diameter of catalyst support is typically in the range of 5 nm to 1000 nm, for example between 10 nm and 100 nm. In particular, the size of the catalyst particles may be about one tenth the size of the catalyst support.

### EXAMPLE

Preparation of Catalyst Support

0.4109 g of ammonium tungstate was added to 250 ml of H₂O and refluxed until the ammonium tungstate dissolved. 1 g of Vulcan XC72R was added to the reaction mixture and refluxed overnight. 3.78 g NaBH₄ dissolved in 100 ml water was then added over 2 minutes. The reaction mixture was then refluxed for a further 20 minutes before being left to cool and settle. The solid W/C material was then filtered, washed, dried and ground.

After the tungsten was deposited on the carbon support, the sample was subjected to a heat treatment for one hour at 900° C. in nitrogen.

Preparation of Supported Catalyst

3.444 g NaHCO₃ was dissolved in 200 ml H₂O in a 500 ml round bottom flask. 0.6 g of the treated catalyst support was then added to the reaction mixture. 1 g H₂PtCl₆ dissolved in 60 ml H₂O was added dropwise using an addition funnel over several minutes. The mixture was then refluxed for two hours. 780 μl formaldehyde solution (37%) in 7.8 ml H₂O was added by dropwise by addition funnel over about one minute. The mixture was allowed to react and then refluxed for another two hours before filtering, washing, drying and grinding as before. The catalyst was 40% platinum on W/C support.

Testing Oxidative Stability

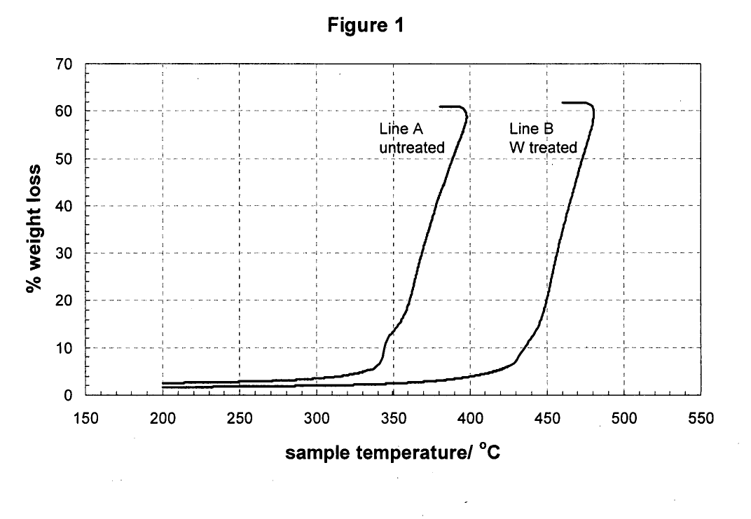

Thermal gravimetric analysis (TGA) was used to determine the stability of catalyst to oxidation in pure, flowing oxygen as the temperature was ramped from 50° C. to 1000° C. at 10° C./min. The oxygen flow rate was 40 ml/min. The results are shown in FIG. 1. Line A shows the results for catalyst HiSpec 4000 obtained from Johnson Matthey which comprises 40% platinum on Vulcan XC72R. Line B shows the results obtained for the catalyst as prepared above having a W/C support.

The untreated XC72R catalyst starts to oxidize at 330° C. In comparison, the tungsten treated XC72R based catalyst does not show oxidation until almost 430° C. Thus, the addition of tungsten has imparted considerable oxidative stability to the catalyst. Both the untreated XC72R catalyst and the tungsten treated catalyst showed a total weight loss of 60% indicating that the catalyst is 40% platinum.

In an additional ex situ oxidative stability test, the untreated catalyst and the tungsten treated catalyst were each dispersed in 2 ml glacial ethanoic acid using ulstrasound. The untreated catalyst is the same HiSpec 4000 catalyst obtained from Johnson Matthey comprising 40% platinum on Vulcan XC72R as support and as used above with respect to FIG. 1. The tungsten treated catalyst was also the same as prepared above and used with respect to FIG. 1.

Using a micropipette, 5 μl of the suspension was dispensed onto the flat surface of a polished vitreous carbon rotating disc electrode (RDE). The solvent was gently evaporated with a hot air evaporator leaving a known amount of supported catalyst (about 20 μg) on the RDE. Using the same micropipette, 5 ml of 5% alcoholic Nafion® solution having an equivalent weight of 1100, was dispensed onto the RDE. The solvent was allowed to slowly evaporate in still air under a glass cover such that a coherent Nafion® film was cast over the catalyst and the RDE. The RDE was then immersed in deoxygenated 0.5M H₂SO₄ at 30° C. and rotated at 2000 rpm (33.33 Hz). The cell comprised a glass working compartment with a water jacket connected to a circulating water bath, and two side compartments. One of the side compartments contained the Pt gauze counter electrode connected by a gauze frit and the second contained the RHE reference electrode connected by a Luggin capillary.

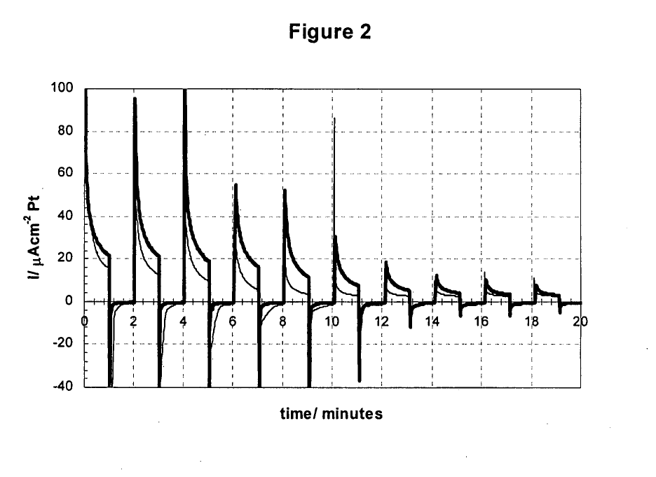

Using either the EG&G 263 or the Solartron 1286 potentiostats with Corrware software from Scribner Associates, a cyclic voltammogram was recorded for 10 cycles between +1.8 V and +0.6 V with 1 minute at each potential. The results are shown in FIGS. 2-4.

FIG. 2 illustrates the ex-situ electrochemical oxidation of platinum catalysts on both untreated carbon supports and tungsten treated carbon supports a function of time for the 10 cycles. The thin dark line represents the results obtained for the catalyst comprising untreated Vulcan XC72R catalyst support and the thicker line shows the results obtained for the catalyst comprising the tungsten treated carbon support. FIG. 2 clearly shows performance decreases over time at a faster rate when an untreated catalyst support is used as compared to the tungsten treated catalyst support.

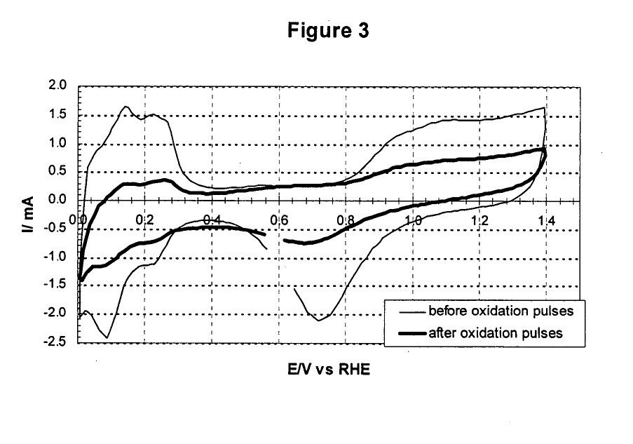

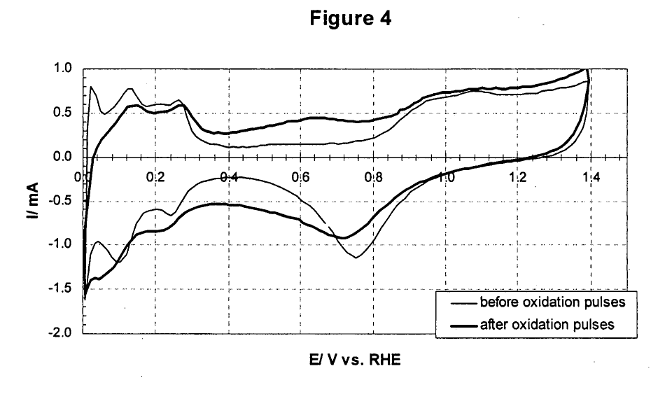

FIG. 3 illustrates cyclic voltammograms of the untreated carbon supported catalyst both before and after the oxidation cycle. The thin dark line shows the cyclic voltammogram of the untreated carbon supported catalyst prior to the oxidation cycle and the thick dark line shows the cyclic voltammogram obtained after the oxidation cycle. From FIG. 3, a loss of platinum surface area of about 80% can be seen. In comparison, FIG. 4 illustrates cyclic voltammograms of the tungsten treated carbon supported platinum catalyst both before and after the oxidation cycle. The thin dark line shows the cyclic voltammogram of the tungsten treated carbon supported catalyst prior to the oxidation cycle and the thick dark line shows the cyclic voltammogram obtained after the oxidation cycle. The tungsten treated carbon supported catalyst only had a loss of platinum surface area of about 40%, less than half that lost as shown above for the untreated carbon supported catalyst in FIG. 3. Without being bound by theory, the loss of activity of the platinum catalyst is assumed to be due to the carbon corrosion and loss of connectivity between the platinum particles and the carbon support.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

1. A catalyst for an electrochemical fuel cell comprising:
a catalyst support comprising carbon and a metal surface treatment on the carbon; and
a metal catalyst deposited on the catalyst support.

2. The catalyst of claim 1 wherein the metal surface treatment comprises a metal carbide surface treatment.

3. The catalyst of claim 1 wherein the metal in the metal surface treatment is titanium, tungsten or molybdenum.

4. The catalyst of claim 3 wherein the metal surface treatment comprises a metal carbide surface treatment.

5. The catalyst of claim 1 wherein the metal catalyst is platinum or a platinum alloy.

6. The catalyst of claim 1 wherein the carbon is a carbon black.

7. The catalyst of claim 1 wherein the carbon is a graphitized carbon.

8. The catalyst of claim 1 wherein the carbon is doped with boron, nitrogen or phosphorus.

9. The catalyst of claim 1 wherein the metal surface treatment substantially covers the entire surface of the carbon.

10. A catalyst ink comprising the catalyst of claim 1.

11. A membrane electrode assembly for an electrochemical fuel cell comprising:
an anode and a cathode fluid diffusion layer;
an ion-exchange membrane interposed between the fluid diffusion layers;
an anode catalyst layer comprising an anode catalyst interposed between the anode fluid diffusion layer and the ion-exchange membrane; and
a cathode catalyst layer comprising a cathode catalyst interposed between the cathode fluid diffusion layer and the ion-exchange membrane;
wherein at least one of the anode and cathode catalysts comprises a catalyst support and a metal catalyst deposited on the catalyst support, and wherein the catalyst support comprises carbon and a metal surface treatment on the carbon.

12. The membrane electrode assembly of claim 11 wherein the at least one of the anode and cathode catalysts is the cathode catalyst.

13. The membrane electrode assembly of claim 11 wherein the metal surface treatment comprises a metal carbide surface treatment.

14. The membrane electrode assembly of claim 11 wherein the metal in the metal surface treatment is titanium, tungsten or molybdenum.

15. The membrane electrode assembly of claim 14 wherein the metal surface treatment comprises a metal carbide surface treatment.

16. The membrane electrode assembly of claim 11 wherein the metal catalyst is platinum or a platinum alloy.

17. The membrane electrode assembly of claim 11 wherein the carbon is a carbon black.

18. The membrane electrode assembly of claim 11 wherein the metal surface treatment substantially covers the entire surface of the carbon.

19. An electrochemical fuel cell comprising the membrane electrode assembly of claim 11.

20. An electrochemical fuel cell stack comprising at least one fuel cell of claim 19.

21. A fuel cell electrode structure comprising a substrate and a catalyst disposed on a surface of the substrate, the catalyst comprising:
a catalyst support comprising carbon and a metal surface treatment on the carbon; and
a metal catalyst deposited on the catalyst support.

22. The fuel cell electrode structure of claim 21 wherein the substrate is a fluid diffusion layer.

23. The fuel cell electrode structure of claim 21 wherein the substrate is an ion-exchange membrane.

24. The fuel cell electrode structure of claim 21 wherein the metal surface treatment comprises a metal carbide surface treatment.

25. The fuel cell electrode structure of claim 21 wherein the metal in the metal surface treatment is titanium, tungsten or molybdenum.

26. The fuel cell electrode structure of claim 25 wherein the metal surface treatment comprises a metal carbide surface treatment.

27. The fuel cell electrode structure of claim 21 wherein the metal catalyst is platinum or a platinum alloy.

28. The fuel cell electrode structure of claim 21 wherein the carbon is a carbon black.

29. The fuel cell electrode structure of claim 21 wherein the metal shell substantially covers the entire surface of the carbon.

30. A method of making a catalyst for an electrochemical fuel cell comprising:
depositing a metal on a surface of a catalyst support comprising carbon;
heating the catalyst support to form a metal carbide surface treatment on the catalyst support; and
depositing a metal catalyst on the catalyst support.

31. The method of claim 30 wherein the metal is selected from tungsten, titanium and molybdenum.

32. The method of claim 30 wherein the heating step is from 850-1100° C.

33. The method of claim 30 wherein the heating step is from 900-1000° C.

34. The method of claim 30 wherein the depositing and heating steps occur sequentially.

35. The method of claim 34 further comprising providing a metal precursor prior to the depositing step and wherein the depositing step comprises reducing the metal precursor.

36. The method of claim 34 wherein the metal precursor is a metal carbonate.

37. The method of claim 34 wherein the metal precursor is ammonium tungstate.

38. The method of claim 30 wherein the depositing and heating steps occur simultaneously.

39. The method of claim 38 further comprising providing a metal precursor prior to the depositing step.

40. The method of claim 39 wherein the metal precursor is an organometallic.

41. The method of claim 40 wherein the organometallic is a TYZOR organic titanate.
